(19) United States
(12) Patent Application Publication
(10) Pub. No.: US 2011/0031722 A1
(43) Pub. Date: Feb. 10, 2011

(54) Airbag

(75) Inventors: Karl-Heinz Baumann, Bondorf (DE); Andreas Hirth, Dielheim (DE); Lutz Quarg, Boeblingen (DE); Friedrich Reiter, Sindelfingen (DE); Clark Ruedebusch, Holzgerlingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/920,428

(22) PCT Filed: Jan. 20, 2009
(86) PCT No.: PCT/EP2009/000305

§ 371 Date: Oct. 21, 2010

(30) Foreign Application Priority Data
Mar. 1, 2008 (DE) 10 2008 012 137.1

(51) Int. Cl. B60R 21/16

(52) U.S. Cl. 280/728.1

(57) ABSTRACT

An airbag for a motor vehicle, with a support structure, by which the airbag can be moved out of a storage position into a retaining position includes an envelope, by which a retaining volume of the airbag formed by the support structure in the retaining position is surrounded. At least one opening is provided in the envelope, which can be at least partially closed in the retaining position of the airbag.

This application is a national stage of PCT International Application No. PCT/EP2009/000305, filed Jan. 20, 2009, which claims priority under 35 U.S.C. §119 to German Patent Application No. 10 2008 012 137.1, filed Mar. 1, 2008, the entire disclosure of which is herein expressly incorporated by reference.

### BACKGROUND AND SUMMARY OF THE INVENTION

The invention relates to an airbag, particularly for use in a motor vehicle.

Airbags which are known in the field of motor vehicle construction are usually moved from a storage position into a retaining position by filling an envelope with gas in the case of an accident, in order to protect a vehicle occupant from serious injuries.

One object of the present invention is to provide an airbag, which can be moved from the storage position into the retaining position in a different manner.

Another object of the invention is to provide an airbag that is optimized with regard to the required opening time and the required retaining effect.

These and other objects and advantages are achieved by the airbag according to the invention which can be moved from a storage position into a retaining position by a support structure that will be explained in more detail in the following—can be deployed in a mechanical manner, or can comprise a channel system of several tubular individual channels, which are fillable with a corresponding medium, such as a gas.

The airbag further comprises an envelope, by means of which a retaining volume formed by the support structure in the retaining position of the airbag is surrounded. In other words, a volume is correspondingly spanned by the support structure, which is surrounded by the envelope.

The airbag according to the invention finally comprises at least one opening within the said envelope, which opening can be closed at least partially in the retaining position of the airbag. This opening is required when transferring the airbag from the storage position into the retaining position, so that the developing retaining volume can correspondingly be filled with the ambient air. This can for example be visualized as a soap bubble ring, wherein the support structure with the envelope during the transfer from the storage position into the retaining position is effected in a correspondingly quick manner, so that the ambient air reaches the forming retaining volume of the airbag via the at least one opening.

According to the invention, the at least one opening can correspondingly be closed at least partially towards the end of the deployment or at the start of the retaining of the airbag, so that the air captured within the retaining volume or by the envelope cannot escape too quickly. Rather, a sufficient resistance for retaining is set against the person bounding towards the airbag.

In a further arrangement of the invention, it is advantageous if the opening in the envelope can be closed at least partially in the retaining position of the airbag by a person to be retained and/or by a component of the motor vehicle. That is, the opening within the envelope can for example be closed partially in that a person—for example a seat occupant—impinges the airbag correspondingly in such a manner that this closes the opening at least partially and thereby influencing the retaining of the airbag. Additionally or alternatively, components of the motor vehicle, in particular of the passenger compartment, can be used for the at least partial closing. Example for this are the windshield or the dashboard, by means of which the airbag is for example closed at least partially after the complete deployment into its retaining position.

In a further arrangement of the invention, the opening in the envelope in the retaining position of the airbag can be closed at least partially. Such a closing device is based on an at least partial mechanical closing of the opening before (or in) the retaining position of the airbag, in order to influence the retaining of the airbag during the impinging of the person, for example the seat occupant.

The closing device can for example comprise a strap element or the like, by means of which the opening in the envelope can be closed at least partially. An at least partial closure of the envelope in the manner of a draw-string pack results thereby.

Alternatively, the closing device can comprise a flap element with at least one flap, by means of which the opening in the envelope can be closed at least partially. The flap element can thereby function as a type of non-return valve, so that air can correspondingly flow into the retaining volume, but cannot, or only partially escape therefrom.

The closing device can further comprise a baffle element in an advantageous embodiment, which element has for example two layers with openings offset from one another, which can be displaced in such a manner to each other that the openings close at least partially.

The closing device can finally also be formed by at least one closing element of the envelope itself, by which the opening in the envelope can be closed at least partially. In other words, the closing elements are thus formed by the envelope itself, in order to close the opening at least partially for example by means of a form-lock or the like, when a certain retaining volume of the airbag is reached.

According to a feature of the invention, a support structure is again provided which can be moved from a storage position, into a retaining position, and which is surrounded by an envelope, by which a retaining volume formed by the support structure in the retaining position of the airbag is surrounded.

Furthermore, at least one region of the envelope is provided thereby whose air through-flow direction and/or air permeability can be changed. In other words, the envelope can for example be formed in such a manner that it can be flown through in one air flow-through direction, while it cannot be flown through in the other air flow-through direction and thus closes the opening. Additionally or alternatively, the air permeability of the region that forms an opening can be different. As a result, air can flow through the corresponding region of the envelope during the deployment of the airbag, in order to form an opening, through which the air can flow into the retaining volume or into the interior of the envelope. In order to ensure a retaining function, the region of the envelope in the opposite direction can be closed at least partially, in order to at least partially avoid or to decelerate an escape of the air captured within the envelope. The deployment and retaining behavior of the airbag is again influenced by the corresponding region of the envelope as a result.

In a further arrangement of the invention, the air flow-through direction and/or the air permeability of the region of the envelope can be changed in an automatically controlled manner. In other words, the envelope itself can be formed of a corresponding material, fabric or the like in such a manner that its gas permeability changes, for example when the surface tension changes, such as during a deployment or a load. This could for example be achieved by e.g., threads, regions, flaps, surfaces, layers or others in the envelope itself which displace, enlarge and/or rotate during tensile stress.

It has further been shown to be advantageous if the air flow-through direction and/or the air permeability in the region of the envelope can be changed by means of an outer control. Such an outer control can for example be a pneumatic device or a corresponding current or voltage, by which the region of the envelope is accessed in such a manner that the gas permeability is e.g., reduced or stopped.

It has finally been shown to be advantageous if the air flow-through direction and/or the air permeability of the region of the envelope can be changed by providing it with a liquid. The flow-through capability can thus be reduced, for example, by wetting the envelope or its fabric in order to achieve a corresponding retaining function.

Other objects, advantages and novel features of the present invention will become apparent from the following detailed description of the invention when considered in conjunction with the accompanying drawings.

### BRIEF DESCRIPTION OF THE DRAWINGS

FIG. 1 is a sectional perspective view of an airbag for a motor vehicle, presently in the form of a passenger motor vehicle, wherein the airbag comprises a support structure with a plurality of flexible channels combined to a channel arrangement, which can be filled with gas, whereby the support structure or the airbag can be moved from a storage position into the retaining position shown here, which is surrounded by an envelope, and wherein the envelope is presently formed of a plurality of surface elements which extend between the framework-like channels;

FIG. 2 is a schematic side view of an airbag for a motor vehicle (depicted as a as a passenger motor vehicle) according to that invention, wherein the airbag is arranged at the rear of a front vehicle seat and comprises a mechanical support structure, which can for example be moved from a storage position into a retaining position by means of spring elements. The mechanical support structure is surrounded by an envelope, by which a retaining volume formed by the support structure in the retaining position is surrounded for retaining the seat occupant of a rear vehicle seat;

FIG. 3 is a schematic sectional view through an airbag with a support structure according to one of the embodiments shown in FIG. 1 or FIG. 2, wherein at least one opening is provided within the envelope surrounding the support structure, which opening can be closed at least partially in the retaining position of an airbag shown here, namely in the present case by a person to be retained and/or by a component of the motor vehicle as for example a dashboard or a windshield;

FIG. 4 is a schematic perspective depiction of a closing device, by which the opening in the envelope of the airbag can be closed at least partially in its retaining position, wherein the closing device presently comprises a flap element with a plurality of flaps, by means of which the opening in the envelope can be closed at least partially;

FIG. 5 is a further perspective sectional depiction of an airbag with a closing device for the at least partial closing of the opening in the envelope, which comprises a baffle element, by means of which the opening in the envelope can be closed at least partially, wherein the baffle element presently comprises two baffle parts provided with through-holes, which can be displaced with regard to one another in such a manner that the opening within the envelope is closed at least partially; and in

FIG. 6 is a schematic side view of an airbag for a motor vehicle formed as a passenger motor vehicle, wherein an envelope indicated schematically which surrounds the support structure presently comprises a closing device with at least two closing elements of the envelope itself, by means of which the opening in the envelope can be closed for forming the retaining volume.

### DETAILED DESCRIPTION OF THE DRAWINGS

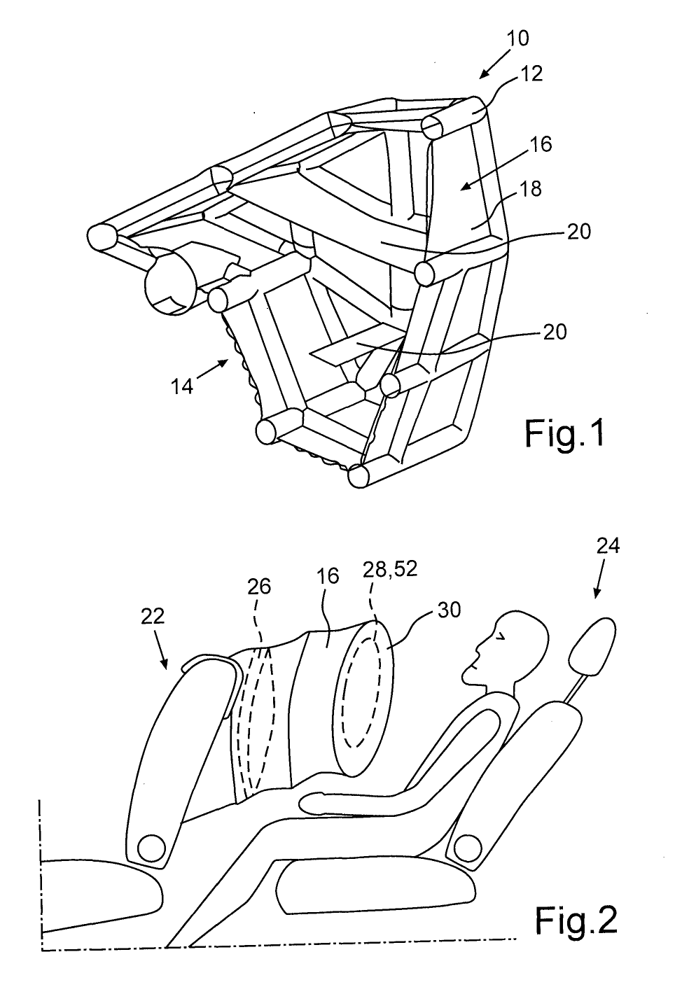

In FIG. 1, an airbag for a passenger motor vehicle can be seen in a perspective sectional view in its retaining position. The airbag thereby comprises a support structure 10, which presently is formed of a plurality of hollow channels 12 connected in a framework-like fashion, forming a channel system. The support structure 10 can thereby be moved from a storage position, in which the airbag is stored within the passenger motor vehicle, into a the retaining position shown in FIG. 1, in which the support structure 10 or its hollow channels 12 are filled with a gas. The support structure 10 hereby deploys into the form shown in FIG. 1, namely while enclosing a retaining volume 14 formed.

This retaining volume 14 is essentially surrounded by an envelope 16, which is formed by a plurality of surface elements 18 of a material, fabric or the like. The envelope 16 is thereby correspondingly flexible, as are the hollow channels 12.

In contrast to conventional airbags, the retaining volume 14 is created by the support structure 12, into which volume a passenger is then moved during a corresponding accident. Further connection elements 20 such as tie rods or the like can thereby be seen within the support structure 10, which can influence the form or the deployment behavior of the support structure 10 or of the airbag into the retaining position.

In FIG. 2 is shown a further airbag in its retaining position in a side view. The airbag is arranged at the rear side of a front vehicle seat 22 and serves for retaining a seat occupant positioned on a rear vehicle seat in the case of a collision. The airbag is shown in its deployed retaining position, in which it has been deployed from a storage position near the backrest at the driver's seat 12 corresponding to the direction of the seat occupant of the rear vehicle seat 24.

In contrast to the airbag according to FIG. 1, a mechanical support structure 26 is presently provided, which can move the airbag from the storage position into the retaining position. Such a mechanical support structure 26 can for example comprise a plurality of metal ledges or the like, which are connected as a scissor mechanism, a flap mechanism or the like in such a manner that the support structure 26 can be moved from a retracted position to an extended position. It is also conceivable for example to use a large spiral spring as support structure 26, which spring is correspondingly extended in the case of an imp act.

The mechanical support structure 26 is presently surrounded again by the envelope 16 already described in connection with the embodiment according to FIG. 1, which envelope itself surrounds a corresponding retaining volume 14 of the airbag.

The problem with the previously described known airbags now consists in achieving a deployment behavior as advantageous as possible on the one hand, and a particularly advantageous retaining of a person in the case of a collision of the motor vehicle.

For this purpose, the present airbags provide at least one opening 28 within the envelope 16, which opening ensures, when deploying or opening the airbag, that ambient air can reach the retaining volume 14 of the airbag and can be closed in the retaining position of the airbag at least partially on the other hand, so that, during impingement of the person, the air correspondingly captured within the retaining volume 14, cannot escape too quickly, but that a sufficient retaining effect of the airbag results. During the deployment of the of the support structure 10, which is surrounded by the envelope 16, ambient air is thus enclosed, which reaches the airbag via the opening 28. With the enclosure of ambient air, is meant the spanning of the air and its—at least partial—enclosure, wherein the air shall not be moved or displaced in a considerable manner. This can be compared to the principle of a soap bubble ring for visualization, which is moved correspondingly quickly through the air, wherein air reaches the retaining volume 14 via the opening 28, which volume is delimited by the envelope 16. The opening 28 is thereby—as can be seen in FIG. 2—for example arranged in a front region of the airbag or the envelope 16. It would of course also be conceivable to provide this opening 28 at a different location.

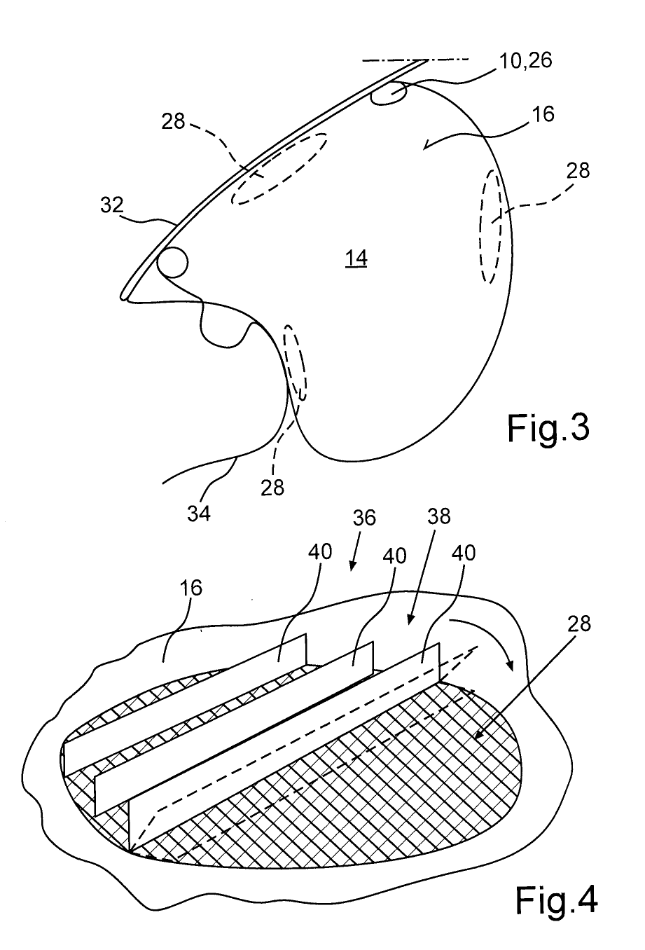

In FIG. 3 shows an airbag in its retaining position in a schematic and lateral sectional view, wherein this comprises a support structure 10 or 26 according to one of the embodiments according to FIG. 1 or FIG. 2. The support structure 10 can accordingly either be formed by gas-filled hollow channels or also as a mechanical support structure 26. The one opening is thereby again provided within the envelope 16, which opening can be closed at least partially in the present case by a person to be retained and/or by a component of the motor vehicle. In other words, the opening 28 is altogether presently arranged in the region of the of the envelope 16 or of the airbag that this is in particular at a location in its retaining position, in which position the opening 28 can be closed at least partially. If this closing shall for example take place by the seat occupant or the person to be retained, the opening 28 accordingly has to be arranged—as can be seen in FIG. 2—in the region of an impingement surface 30 of the airbag. If the seat occupant thus impinges the airbag, the opening 28 within the envelope 16 is closed thereby at least partially and an excessive escape of air from the retaining volume 14 is prevented. In other words, the desired corresponding retaining of the passenger results hereby, so that this is accelerated correspondingly in an advantageous negative manner.

FIG. 3 further shows an alternative in which the opening 28 is for example closed at least partially by a windshield 32 or a dashboard 34. It is hereby achieved again that the air captured within the retaining volume 14 or the envelope 16 cannot escape too quickly. Thus, a sufficiently large opening 28 is provided within the enclosure 16, so that a fast opening of the airbag results, that this opening 28 can correspondingly be closed at least partially on the other hand, in order to achieve a sufficient retaining during the impingement of the seat occupant or the person. The closing of the retaining volume 14 or of the opening 28 can thereby for example take place towards the end of the deployment or at the start of the retaining, that is, when the person to be retained correspondingly impinges the airbag. The at least partial closing of the opening 28 can thus take place in this temporally described section.

In the embodiment according to FIG. 3, it is thus provided that the airbag is for example designed in an open manner by the opening 28 in particular in the deployment direction, and is for example only delimited by side and rear walls which correspondingly enclose the ambient air during the deployment, wherein the occupant then closes the opening 28 from the front during his impingement on the airbag. An adaptivity or adaptation of the hardness of the airbag to the respective occupant to be retained also results thereby.

In the region of the opening 28, sealing lips, silicon edges or siliconized fabrics, seals can be provided via a form-lock, force-lock or a mixture thereof, in order to influence the sealing of the opening 28. In influence of the shaping of the support structure 10 or of the airbag can also be provided by the omission of the region of the envelope 16, in which the opening 28 is provided, or for example by the connection elements 20, as they are already described in connection with the embodiment according to FIG. 1. The shaping changed by the partial omission of the envelope can thus e.g., be adjusted at least partially.

As an alternative to the possibility of closing the opening 28 by the occupant to be restrained and/or by a component of the motor vehicle, it is also possible that the airbag comprises a closing device, by means of which the opening 28 can be closed at least partially.

Such a closing device 36 is for example already shown in FIG. 4, namely in a sectional and highly schematic perspective. The opening 28 is covered with a grate or net-like part 22, wherein the flaps 40 in their open position proceed approximately transversely or vertical to this part 42. The opening 28 can be flown through in the open position of the flaps 40. If—as depicted by the arrow—the flaps 40 are now pivoted into a position parallel to the part 42 or abutting this, the opening 28 is logically closed. By a suitable arrangement of the flap element 38 or of the flaps 40 it is thus possible to keep the flaps open on the one hand during the deployment of the airbag, while they can correspondingly be closed at least partially in the retaining position that the prescribed retaining of the seat occupant impinging on the airbag results. In other word, the part 42 with the flaps 40 formed as an air-permeable layer penetrates the ambient air during the deployment of the retaining volume 14 and encloses this retaining volume by closing the flaps 40. The closing of the flaps 40 can thereby also be controlled via the deployment of the retaining volume 14, for example restraining straps, which close the flaps 40 towards the end of the deployment.

As an alternative to this embodiment, the closing device 16 can also comprise a strap element or the like, by means of which the opening 28 can be closed according to a draw-string pack. This is a principle which is generally used as a fish mouth principle.

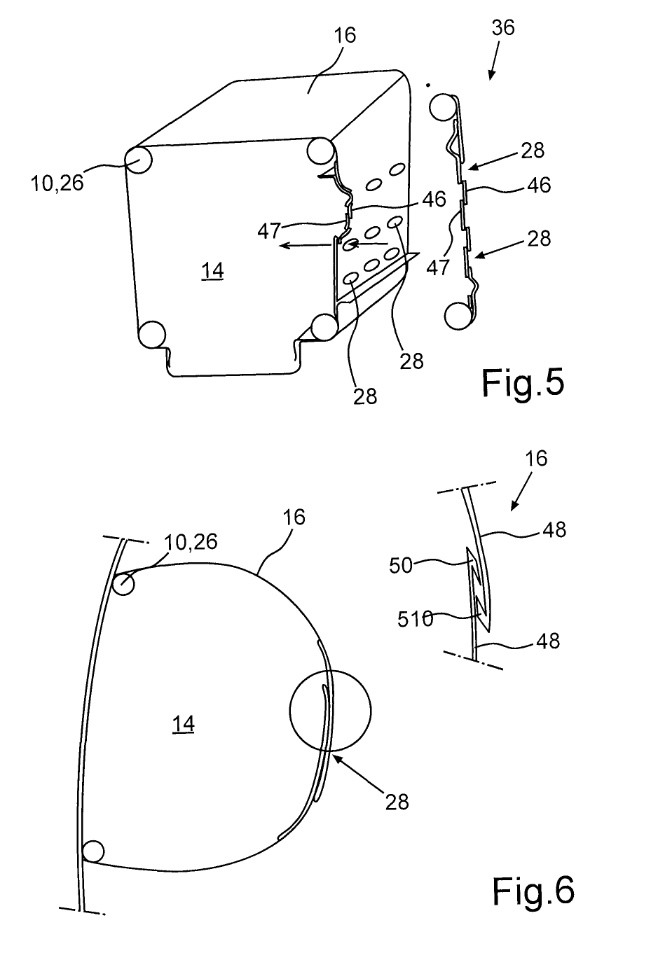

FIG. 5 again shows an airbag in a schematic perspective view, which has a support structure 10 or 26 with a corresponding envelope 16. In the present case, a baffle element 44 is thereby provided in the region of a plurality of openings 28. As can be seen in the enlarged lateral sectional view, this baffle element comprises two baffle parts 46, 47 arranged in parallel, which can be moved against each other in their respective extension direction. In other words, the baffle parts 46, 47 are two offset layers which are permeable or virtually impermeable or impermeable according to the requirements of the dampening effect. If the baffle parts 46, 47 are thus moved against each other, the opening 28 is closed at least partially in order to achieve a correspondingly advantageous retaining of the airbag. If the openings are however opened completely, a particularly advantageous deployment of the airbag results. The layers or the baffle parts 46, 47 can thereby take on different functions, one of the layers can for example be responsible for the carrying effect and the other one for the sealing effect. The displacement of the two layers or baffle parts 46, 47 can for example take place by the deployment and/or the tightening of the envelope 16 and/or the support structure 10 or 26.

In FIG. 6, an airbag in its retaining position is shown in an extremely schematic side view, wherein the envelope 16 comprises two free ends 48, through which the opening 28 is formed. As shown in the enlarged detail depiction according to FIG. 6, the closing device 36 thereby comprises respective closing elements 50, 51, which are provided at the respective ends 48 of the envelope 16. The two closing elements are presently formed in a hook-like manner, so that a form-lock results between the two closing elements 50, 52 with a completely deployed retaining volume 14, which form-lock closes the opening 28. In other words, the two ends 48 of the envelope 16 are combined towards the end of the deployment that they can seal against each other themselves. This can take place by a form-lock—as is the case here—in a particularly advantageous manner. A force-lock or a mixture of the connections is however also conceivable. This type of deployment can be visualized as a spherical lantern, which spans the retaining volume 14, wherein the respective edges approach each other towards the end of the deployment. These can then hook into each other (form-lock) and/or overlap (force-lock). With the overlapping, a tight overlapping with a friction as high as possible and with a sufficient overlapping length is advantageous. This can for example take place with a siliconized fabric, possibly with seams.

An embodiment alternative to the embodiments according to FIGS. 1 to 6, which again comprises a support structure 10 or 26 with a corresponding envelope for enclosing a retaining volume 14, can be achieved in that a region 52 (FIG. 2) is provided instead of the opening 28, whose air flow-through and/or air permeability can be changed. In other words, at least one region 52 of the envelope 16 shall be provided presently which has a changeable flow-through capability so that ambient air can reach the retaining volume 14 when deploying the airbag on the one hand, but this can only leave the retaining volume 14 in a decelerated manner on the other hand when reaching the retaining position.

The flow-through capability can thereby for example result by a changed alignment or expansion of possibly anisotropic structures of the envelope 16. This can for example take place by the fabric itself or by structures formed e.g., by the fabric.

The air flow direction and/or the air permeability corresponding to the region 52 of the envelope 16 can thereby be changed with an automatic control. It is for example conceivable that the region 52 of the envelope 16 can be automatically controlled by the air flow, e.g., permeable in one flow direction and less permeable or non-permeable in the other one. It would also be conceivable to influence the automatic control by means of the surface tension, for example by rotation of surfaces for closing openings or the like.

As an alternative to this, the air flow-through direction and/or the air permeability of the region 52 of the envelope 16 can also be adjusted by respectively an outer control, for example by a pneumatic means according to a pneumatic muscle, which expands correspondingly and thereby changes the air flow-through direction and/or the air permeability of the region 52. It would also be conceivable to carry out the outer control by means of current or voltage, in order to for example control a bimetal, a piezo crystal or a magnetic element, which hereby changes the air flow-through direction and/or the air permeability of the region 52.

In a further embodiment, the air flow-through direction and/or air permeability of the region 52 can be influenced in that it is provided with a liquid. By wetting the region 52, the flow-through capability is thus correspondingly reduced, wherein this advantageously takes place with a liquid having a high polarity and/or surface tension. It is obvious that a webbing of the region 52 of the envelope 16 adjusted thereto is necessary for this. It is however achieved altogether by means of the region 52 that ambient air can reach the interior of the airbag on the one hand and leave the airbag at the most correspondingly in a decelerated manner for ensuring a particularly good retaining.

It shall thereby be viewed within the scope of the invention that combinations of openings 28 and regions 52 of the envelope 16 are also possible in principle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-11. (canceled)

12. An airbag for a motor vehicle, said airbag comprising:
a support structure, by which the airbag can be moved out of a storage position into a retaining position;
an envelope which surrounds a retaining volume of the airbag formed by the support structure in the retaining position; and
at least one opening formed in the envelope, which opening can be at least partially closed in the retaining position of the airbag.

13. The airbag according to claim 12, wherein the opening in the envelope in the retaining position of the airbag can be closed at least partially by one of a person that is to be restrained and a component of the motor vehicle.

14. The airbag according to claim 13, wherein the opening in the envelope can be closed at least partially in the retaining position of the airbag by means of a closing device of the airbag.

15. The airbag according to claim 14, wherein the closing device comprises a strap element, by which the opening in the envelope can be closed at least partially.

16. The airbag according to claim 14, wherein the closing device comprises a flap element with at least one flap, by which the opening in the envelope can be closed at least partially.

17. The airbag according to claim 14, wherein the closing device comprises a baffle element, by which the opening in the envelope can be closed at least partially.

18. The airbag according to claim 14, wherein the closing device comprises at least one closing element of the envelope itself, by which the opening in the envelope can be closed at least partially.

19. An airbag for a motor vehicle, said airbag comprising:
a support structure which can move the airbag from a storage position into a retaining position;
an envelope which surrounds a retaining volume of the airbag formed by the support structure in the retaining position of the airbag; and
at least one region of the envelope having an air flow-through direction or air permeability that is modifiable.

20. The airbag according to claim 19, wherein the air flow-through direction or air permeability of the region of the envelope is modifiable in an automatically controlled manner.

21. The airbag according to claim 19, wherein the air flow-through direction or air permeability of the region of the envelope is modifiable by an outer control.

22. The airbag according to claim 19, wherein the air flow-through direction or the air permeability of the region of the envelope is modifiable by providing it with a liquid.
